(19) United States
(12) Patent Application Publication
(10) Pub. No.: US 2015/0314271 A1
(43) Pub. Date: Nov. 5, 2015

(54) HYDROGEN DISSOCIATION CATALYST COMPRISING IR-AU ALLOY

(71) Applicant: KOREA INSTITUTE OF SCIENCE AND TECHNOLOGY, Seoul (KR)

(72) Inventors: Sang Soo HAN, Seoul (KR); Hyungjun KIM, Daejeon (KR); Dong-Hwa SEO, Busan (KR); Hyeyoung SHIN, Daejeon (KR)

(21) Appl. No.: 14/490,463

(22) Filed: Sep. 18, 2014

(30) Foreign Application Priority Data
Apr. 30, 2014 (KR) 10-2014-0052787

(51) Int. Cl. B01J 23/52; C01B 3/00; H01M 4/92

(52) U.S. Cl. CPC B01J 23/52; H01M 4/921; C01B 3/0094; C01B 2203/1064

(57) ABSTRACT

A hydrogen dissociation catalyst of the present invention includes an alloy in which two metals are intermingled with each other, the alloy being an Ir—Au alloy which is a functional alloy, and the hydrogen dissociation catalyst has an activity for a hydrogen oxidation reaction and may replace a platinum catalyst. Economic efficiency may be enhanced by using the hydrogen dissociation catalyst instead of the platinum catalyst.

### CROSS-REFERENCE TO RELATED APPLICATION

Pursuant to 35 U.S.C. §119(a), this application claims the benefit of earlier filing date and right of priority to Korean Application No. 10-2014-0052787, filed on Apr. 30, 2014, the contents of which is incorporated by reference herein in its entirety.

### BACKGROUND OF THE DISCLOSURE

1. Field of the Disclosure

The present disclosure relates to a catalyst comprising an Ir—Au alloy which is a novel functional alloy, and particularly, to a hydrogen dissociation catalyst which may replace a platinum catalyst.

2. Background of the Disclosure

The design of novel functional materials, such as catalysts, has been a long-standing goal in the fields of computational materials science. The successive development of an electronic structure calculation method using density functional theory (DFT) and its accurate predictability with relatively affordable computational costs can be one index showing that this goal is being brought to fruition. Currently, in silico screening of materials has been widely pursued for applications involving lithium ion batteries, fuel-cell catalysts, and gas storage, and others.

Most of the methods employed in computational materials design are based on combinatorics. Within a predetermined search domain, a computational test is performed for nearly every possible combination. In particular, for the development of metallic catalysts, such combinatorial materials screening has been widely employed to search for non-precious (or at least less-precious) or employed to make better metallic alloys.

A solid solution in which metallic elements are homogeneously mixed at the atomistic level can expand the tenability of the chemical and physical properties of the metallic systems beyond the classical alloying technique. Because the constituent elements are completely intermingled with each other at the atomistic level, variations in composition and/or combination allow us to continuously tailor the material's properties. However, thermodynamically, only certain combinations of elements allow the formation of a solid solution, whereas the other combinations favor the formation of a segregated phase. Although this problem has limited the utilization of solid solution phases, several synthesis techniques, such as quenching to yield a metastable state or nanoscale fabrication to stabilize the nonequilibrium phases under ambient conditions, have been developed to prepare solid solution phases at room temperature.

Meanwhile, similar atomic and electronic structures could lead to similar chemical properties. When atomic structures of a pure metal and a solid solution (composed of two metallic elements neighboring with the pure metal) are same, an electronic structure of the pure metal would be similar to one of the solid solution phases of the pure metal due to free electrons of metals. In particular, one can develop a solid solution structured alloy of two metal elements to create new characteristics that are different from the intrinsic qualities of the constituent elements. Therefore, we propose a functional alloy that is an isoelectronic solid solution (ISS) of the two metal elements in order to create new characteristics that are not native to the constituent elements.

### SUMMARY OF THE DISCLOSURE

Therefore, an aspect of the detailed description is to provide a hydrogen dissociation catalyst which has an activity for a hydrogenation reaction, respectively, and may replace a platinum catalyst by proposing an Ir—Au alloy which is a novel functional alloy.

A hydrogen dissociation catalyst according to an exemplary embodiment of the present invention is a catalyst including an alloy in which two metals are intermingled with each other, the alloy being an Ir—Au alloy.

The alloy may be a solid solution.

The catalyst may have an activity for a hydrogen oxidation reaction (HOR), and hydrogen may be adsorbed over the alloy (111) surface.

The catalyst may be used instead of a platinum (Pt) catalyst.

The molar ratio of constituent atoms of the alloy may be 25:75 to 75:25.

The alloy may have a face centered cubic (FCC) structure.

A catalyst composition according to another exemplary embodiment of the present invention is a composition including an alloy in which two metals are intermingled with each other, the alloy being an Ir—Au alloy.

The alloy may be a solid solution.

The composition may have an activity for a hydrogen oxidation reaction.

The molar ratio of constituent atoms of the alloy may be 25:75 to 75:25.

The alloy may have a face centered cubic (FCC) structure.

A hydrogen fuel cell according to still another exemplary embodiment of the present invention includes the aforementioned hydrogen dissociation catalyst or the aforementioned catalyst composition.

A method for oxidizing hydrogen according to yet another exemplary embodiment of the present invention uses the aforementioned hydrogen dissociation catalyst or the aforementioned catalyst composition.

Hereinafter, the present invention will be described in more detail.

The hydrogen dissociation catalyst according to an exemplary embodiment of the present invention is a catalyst including an alloy in which two metals are intermingled with each other, the alloy being an Ir—Au alloy.

The alloy may be a solid solution, and preferably an isoelectronic metal solid solution. When the alloy is a solid solution which is in a state of being uniformly mixed, the activity as a catalyst may be more conspicuously exhibited.

The solid solution refers to a crystal in which some of atoms occupying the lattice sites are substituted with other kinds of atoms without changing the crystal structure in the crystal phase. The solid solution is a term which is compared to the solution, in that the solid solution may be considered as a homogenous phase in which other materials become molten and diffuse into the crystal phase.

The catalyst may have an activity for a hydrogen oxidation reaction. In theory, when any two materials have similar atomic structures, the two materials may have similar physical and chemical properties if the two materials also have similar electronic structures. That is, if the crystal lattices of the atoms are the same, and the electron densities are similar to each other in a specific energy band or energy state, for example, in the Fermi energy state, physical properties or chemical properties to be exhibited may also be similarly shown.

In this regard, the catalyst may be similar to platinum (Pt) in terms of the function thereof, and thus may serve as a catalyst of a reaction in which hydrogen is dissociated, such as a hydrogen oxidation reaction in which a platinum catalyst is usually used, and may be used as a substitute for the platinum catalyst.

Because the Ir—Au alloy and platinum are similar to each other in terms of electron density in the d-orbital band, the electron densities are similar at the Fermi energy, the charge density difference between the two materials is nearly zero, and due to similar locations of Coulomb attraction centers, the Coulombic fields acting on the valence electrons may be similar to each other. Therefore, the Ir—Au alloy and platinum are similar to each other in terms of the electronic structure thereof, and thus have a catalytic activity in a hydrogen oxidation reaction, and the like in which a hydrogen molecule is dissociated into hydrogen atoms to adsorb them onto the catalyst, and hydrogen is dissociated from the reactants.

The crystal lattice structure of the alloy may be a face centered cubic (FCC) structure, a CsCl structure, an NaCl structure, a Wurtzite structure, or a Zinc Blend structure, and preferably, a face centered cubic structure.

When the crystal lattice of the alloy is a face centered cubic structure, it is easy to form a face centered cubic structure and the state where the crystal lattice is a face centered cubic structure is stable because the formation energy for the crystal lattice is lower than the formation energy for the crystal lattice of pure atoms of the constituent atoms of the alloy. Properties of the Ir—Au alloy may be further similar to those of platinum because the crystal lattice structure of the alloy is the same as that of platinum.

The molar ratio of the constituent atoms of the alloy may be 25:75 to 75:25, and preferably, about 50:50. When the molar ratio is in the aforementioned range, the Ir—Au alloy may have a crystal lattice with a face centered cubic structure as described above, and may have a an electronic structure similar to that of platinum, and thus may have an activity as a catalyst in a hydrogen oxidation reaction and the like.

When the alloy is an Ir—Au alloy, the alloy may serve as a platinum catalyst, and the platinum catalyst may serve to adsorb hydrogen on the catalyst while dissociating hydrogen in the molecular state into the atomic state, and accordingly, allow hydrogen to be dissociated from the reactants.

There are total 11 hydrogen adsorption sites present in the platinum catalyst in which the hydrogen molecule is dissociated to be adsorbed as hydrogen atoms, and it may be determined by the hydrogen dissociation reaction energy and the energy barrier of the hydrogen dissociation reaction at each site on what site hydrogen is adsorbed. For the hydrogen adsorption site, adsorption may be achieved on the (111) surface, which is a position where the hydrogen dissociation reaction energy is low, and the energy barrier is low.

That is, because the Ir—Au alloy may have a hydrogen dissociation reaction energy similar to that of a platinum catalyst, and the energy barrier thereof is also similar to that of platinum, the Ir—Au alloy may serve as a catalyst for a hydrogen oxidation reaction in which hydrogen is dissociated.

The catalyst composition according to another exemplary embodiment of the present invention is a composition including an alloy in which two metals are intermingled with each other, the alloy being an Ir—Au alloy.

Because the explanation on the reaction in which the catalyst composition including the Ir—Au alloy has an activity and the Ir—Au alloy is overlapped with the explanation in the hydrogen dissociation catalyst including the aforementioned Ir—Au alloy, the description thereof will be omitted.

The catalyst composition may be applied as an active component to be supported on a specific carrier or as a co-catalyst, in the manufacture of a catalyst for a hydrogenation reaction or a hydrogen oxidation reaction. The catalyst to be manufactured by using the Ir—Au alloy as an active component may be applied as an alternative catalyst to a catalyst which uses platinum as an active component.

The hydrogen fuel cell according to still another exemplary embodiment of the present invention includes a hydrogen dissociation catalyst including the aforementioned Ir—Au alloy or a catalyst composition including the Ir—Au alloy, and the method for oxidizing hydrogen according to yet another exemplary embodiment of the present invention uses a hydrogen dissociation catalyst including the aforementioned Ir—Au alloy or a catalyst composition including the Ir—Au alloy.

The hydrogen fuel cell or the hydrogen oxidation method may use the Ir—Au alloy instead of a platinum catalyst used in the related art to manufacture a hydrogen fuel cell with the economic efficiency improved, and allows an alternative catalyst to be used in oxidizing hydrogen, thereby solving the problem of meeting demand for resources.

Since a hydrogen dissociation catalyst including the Ir—Au alloy of the present invention has an activity for a hydrogen dissociation reaction such as a hydrogen oxidation reaction, the hydrogen dissociation catalyst including the Ir—Au alloy may replace a platinum catalyst. By replacing an expensive precious metal catalyst such as platinum in this manner, an economic profit may be obtained, and the problem in relation to meeting demand for resources may also be solved.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 is a graph illustrating the X-ray diffraction patterns of Ir, Au, and Pt, which are pure metals and an Ir₅₀Au₅₀ alloy which is a binary system solid solution.

FIG. 2 is a schematic view illustrating various atomic arrangements of the Ir₅₀Au₅₀ alloy.

FIG. 3 is a graph illustrating line profiles of the charge density difference between Pt and Ir or Au.

FIG. 4a is a graph illustrating line profiles of the charge density difference between Pt and the Ir₅₀Au₅₀ alloy, and FIG. 4b is a graph illustrating line profiles of the density of states of Ir, Au, and Pt, which are pure metals, and the Ir₅₀Au₅₀ alloy.

FIG. 5 is a graph illustrating the contribution of the density of states of the s-orbital and the d-orbital of Pt and the Ir₅₀Au₅₀ alloy.

FIG. 6 is a schematic view illustrating 11 sites where hydrogen is adsorbed over the Ir₅₀Au₅₀ alloy (111) surface, and energy required for adsorbing hydrogen onto each site.

FIG. 7 is a schematic view comparing the sites where hydrogen is adsorbed over the Pt and the Ir₅₀Au₅₀ alloy (111) surfaces.

FIG. 8 is a graph illustrating line profiles of the density of states of the d-band before Ir, Au, and Pt, which are pure metals, and the Ir₅₀Au₅₀ alloy are bonded to hydrogen.

FIG. 9 is a graph illustrating line profiles of the density of states of the d-band after Ir, Au, and Pt, which are pure metals, and the Ir₅₀Au₅₀ alloy are bonded to hydrogen.

FIG. 10 is a graph illustrating line profiles of energies required for Ir, Au, and Pt, which are pure metals, and the Ir₅₀Au₅₀ alloy to adsorb hydrogen.

FIG. 11 is a schematic view illustrating the atomic arrangements in accordance with variations in composition ratio of each atom relative to the Ir₅₀Au₅₀ alloy.

### DETAILED DESCRIPTION OF THE DISCLOSURE

Description will now be given in detail of the exemplary embodiments, with reference to the accompanying drawings. For the sake of brief description with reference to the drawings, the same or equivalent components will be provided with the same reference numbers, and description thereof will not be repeated.

Hereinafter, exemplary embodiments of the present invention will be described in detail with reference to the accompanying drawings, such that those skilled in the art to which the present invention pertains can easily carry out the invention. However, the present invention can be implemented in various different forms, and is not limited to the exemplary embodiments described herein.

Hereinafter, based on the premise that if specific two materials are similar to each other in terms of atomic and electronic structures, physical/chemical properties of the two materials are also similar to each other, the atomic and electronic structures and chemical properties of a 50:50 Ir/Au alloy will be elucidated, and will be described by comparing them with the isoelectronic system of pure Pt metal (Pt is located between Ir and Au in the periodic table). That is, it will be proved that the Ir₅₀Au₅₀ alloy may dissociate hydrogen (dissociate hydrogen by dissociating a hydrogen molecule into hydrogen atoms) in a similar way to Pt.

The density functional theory (DET) calculations were performed within a plane wave basis set using the initial Vienna Ab-initio Software Package (VASP) to confirm the atomic and electronic structures of the pure metals and solid solutions, the project augmented wave pseudopotential method considering scalar relativistic effects was used, and the Perdew-Burke-Ernzerhof exchange-correlation functional was applied.

All of the calculated structures were fully relaxed under periodic boundary conditions, except for the surface slabs, in which only the nuclei positions were fully relaxed while a and b cell parameters were constrained to the bulk calculated values.

A kinetic cutoff energy of 520 eV and a 10×10×10 k-point mesh were used and a spin-polarization effect was considered. To evaluate the energy barriers for the hydrogen dissociation reaction on metal surfaces, the nudged elastic band (NEB) method with an additional 11 images was used to interpolate between the initial and final states.

### Example 1

### Proof of Similarity Between Atomic Structures of Ir₅₀Au₅₀ and Pt Through XRD Pattern Analysis and Comparison of Formation Energies of Specific Structure

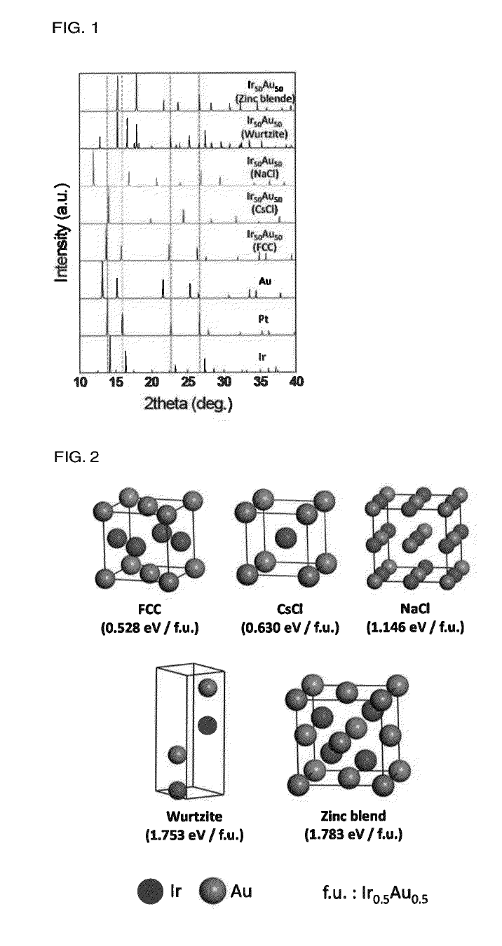

The X-ray diffraction patterns (X-ray wavelength A=supposed as 0.55277 nm) of the Ir50Au50 alloy were simulated, the respective X-ray diffraction patterns of platinum, iridium, and gold were analyzed, and the results thereof are shown in FIGS. 1 and 2.

Referring to FIG. 1, it can be confirmed that the XRD patterns of the Ir₅₀Au₅₀ alloy are similar to those of pure Pt when the Ir₅₀Au₅₀ alloy has the face centered cubic (FCC) structure among several atomic structures. The lattice parameter of the alloy is a value between those of Ir and Au (Ir: 3.876 Å, Au: 4.174 Å vs. Pt: 3.976 Å; Ir₅₀Au₅₀: 4.019 Å), and the Ir and Au atoms are mixed better in the NaCl structure than those in the FCC structure. However, the NaCl structure is thermodynamically less favorable than the FCC structure, and actually, the XRD pattern of the NaCl does not match well with that of Pt. That is, it can be confirmed that of these structures, the FCC structure is most favorable, and the XRD pattern of the structure is most similar to that of Pt.

Further, for respective atomic structures, the formation energies relative to the pure Ir and Au were calculated. Referring to FIG. 2, the formation energy of the FCC structure is positive relative to the pure elements by 0.528 eV per f.u., and is significantly lower than those of other structures, which indicates that Ir and Au intrinsically form a segregated phase in the bulk phase. However, nanosizing of such an intrinsically immiscible alloy and the like can lead to a homogeneous solid solution structure which is stable and homogenous near room temperature. Based on these results, it can be confirmed that the FCC structure is a structure which is suitable for the Ir₅₀Au₅₀ alloy among various atomic structures, which are shown in FIG. 2.

### Example 2

### Proof of Similarity Between Atomic Structures of Ir₅₀Au₅₀ and Pt Through Comparison of Density of State (DOS) and Charge Density Difference

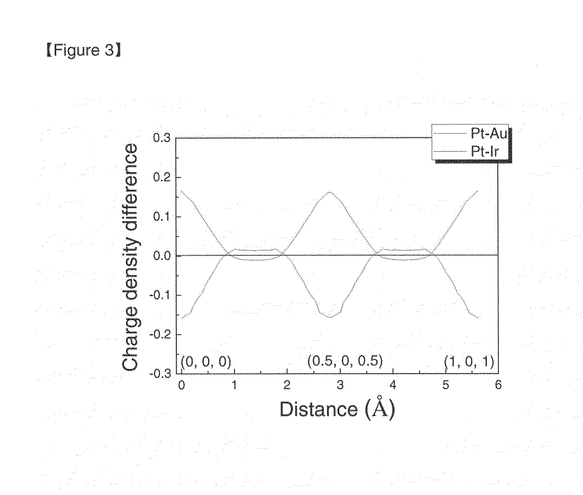

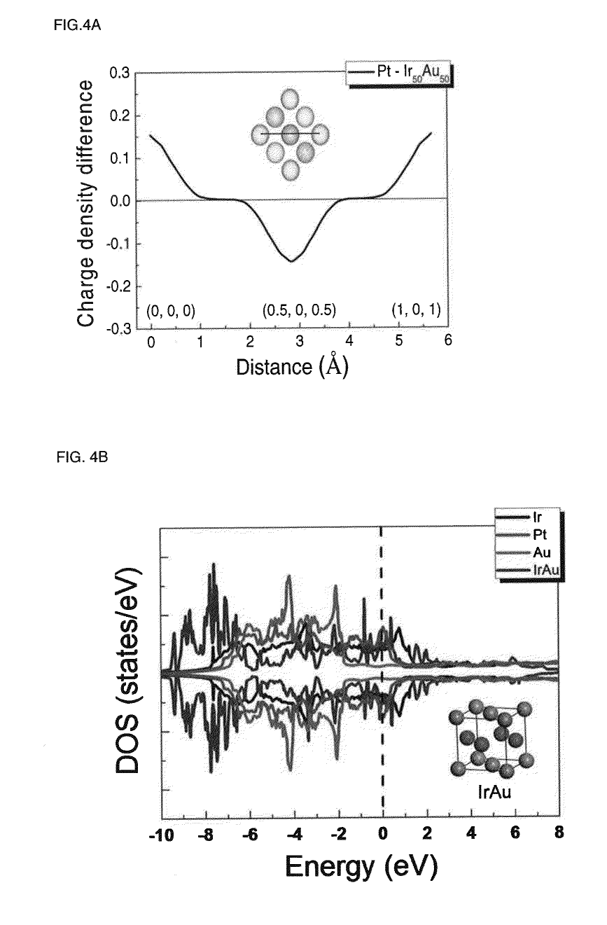

Through the density of state (DOS) and the charge density difference of electrons in the Ir₅₀Au₅₀ alloy system, the Ir₅₀Au₅₀ alloy system was compared with pure Pt metal to investigate the electronic structures thereof near the Fermi energy, respectively. In the case of the charge density difference, line profiles of the charge density difference for the pure metals and the alloy were derived along the [101] direction in their respective structures, and the results are shown in FIGS. 3, 4a, and 4b.

First, referring to FIG. 3, it can be confirmed that when the charge density difference between Pt and Ir or Au is observed, there is no site where the charge density difference is maintained at 0 (that is, the site between the two atoms in which the numbers of electrons are identical), and that similar charge density distributions fail to be exhibited at the bonding regime.

On the contrary, referring to FIG. 4a, it can be seen that for the Ir₅₀Au₅₀ alloy, the (0, 0, 0) and (1, 0, 1) sites are occupied by the Ir atom and the (0.5, 0, 0.5) site is occupied by the Au atom.

Referring to line profiles of FIG. 4a, because the number of electrons in the Pt atom is higher than that in the Ir atom and lower than that in the Au atom, it can be confirmed that the charge density differences at (0, 0, 0) and (1, 0, 1) are positive, while it is negative at (0.5,0,0.5). However, the charge density differences at a specific distance between the two atoms for the Pt and the Ir₅₀Au₅₀ alloy are nearly zero, which confirmed that the numbers of valence electrons in the Pt which is not an alloy and the Ir₅₀Au₅₀ alloy are similar in bonding regime.

That is, through these results, it can be confirmed that the electronic structure of the pure metal Pt is very similar to that of the Ir₅₀Au₅₀ alloy near the Fermi energy. A similarity between the electronic structures of Pt and the Ir₅₀Au₅₀ alloy can be more clearly confirmed through a graph which compares line profiles of the density of states of the respective pure metals and the alloy in FIG. 4b.

### Example 3

### Proof of Similarity Between Atomic Structures of Ir₅₀Au₅₀ and Pt Through Comparison of Free Electron Models of Metal

A similarity between the electronic structures of the pure metal Pt and the Ir₅₀Au₅₀ alloy was additionally proved by considering a free electron model of the metal.

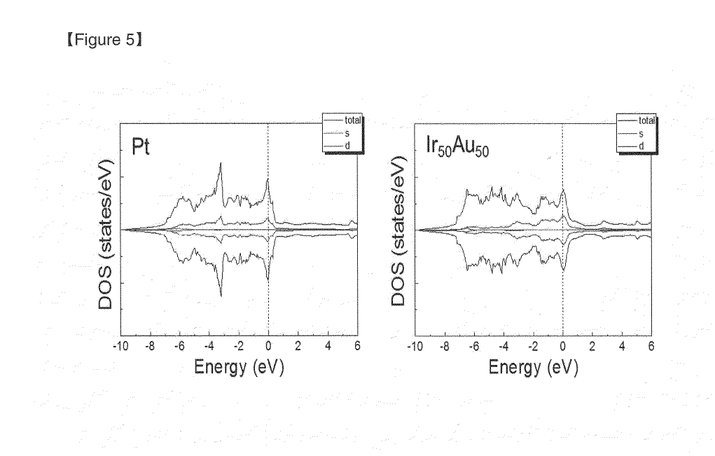

The electronic structure of the metal having the FCC structure near the Fermi energy is primarily determined by the d-electrons (that is, valence electrons) near the Fermi energy, and it can be confirmed that in comparison to the d-orbital electrons, the contribution of the s-orbital electrons near the Fermi energy is less than 1% (see FIG. 5).

The valence electrons experience a Coulombic attraction from the “nuclei+core-electrons” located on every FCC lattice site, and the Ir₅₀Au₅₀ alloy has a lattice parameter which is nearly identical to that of the pure metal Pt (a difference by about 0.01 to 0.1 Å, see Examples 1 and 2), which results in similar locations of Coulomb attraction centers. That is, although the extent of the Coulombic potential is either slightly larger or smaller than the pure metal case, it can be seen that the valence electron experiences similar extent of Coulombic field in both the alloy and the pure metals.

In addition, from FIG. 5, a similarity between valance electrons (d-orbital electrons) of Ir₅₀Au₅₀ and the pure metal Pt can be confirmed. FIG. 4b illustrates the density of states of Ir₅₀Au₅₀ and the pure metal Pt in a graph, and referring to the graph, it can be confirmed that the values of density of states are nearly identical near the Fermi energies of Ir₅₀Au₅₀ and the pure metal Pt, that is, near 0 eV of the energy.

This can be because (1) the Coulomb attraction center in the solid solution is unstable, but the solid solution is homogenous, and an excellent mixture is formed, and (2) for the transition metal, the small perturbation of the nuclei charge has a smaller effect on the dynamics of the valence electrons.

Therefore, through these results, it can be confirmed that the electronic structure of the pure metal Pt is very similar to that of the Ir₅₀Au₅₀ alloy near the Fermi energy.

### Evaluative Example

### Evaluation of Activity of Ir₅₀Au₅₀ Alloy for Hydrogen Oxidation Reaction

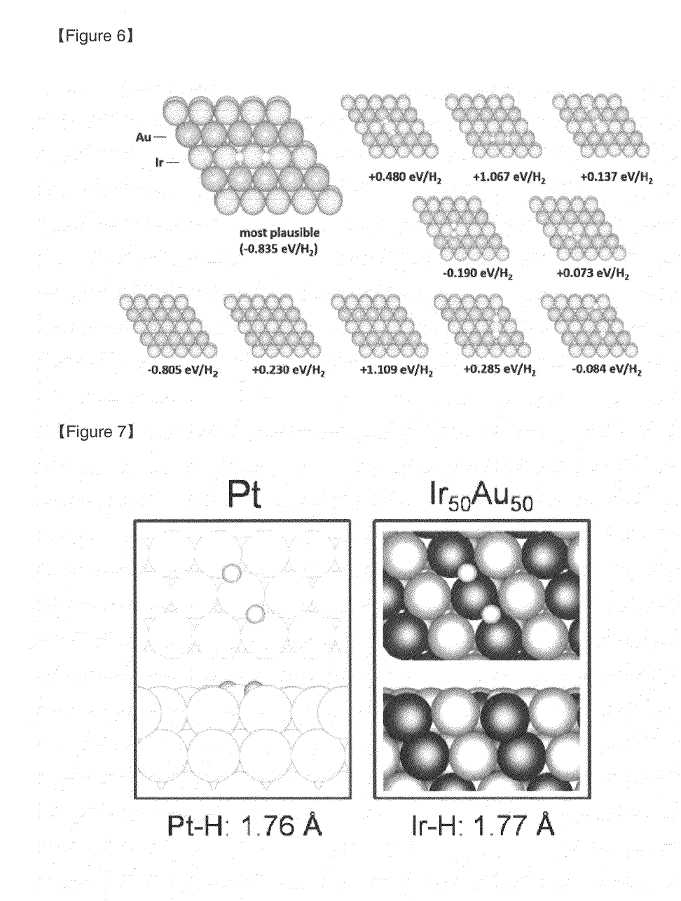

To evaluate whether the Ir₅₀Au₅₀ alloy has an activity for a hydrogen oxidation reaction (that is, a reaction's catalytic function of detaching hydrogen from the reactants by chemically adsorbing hydrogen), the most preferential site was found among 11 sites where hydrogen is adsorbed over the Ir₅₀Au₅₀ alloy (111) surface by using the density functional theory (DFT) calculation equation to calculate the chemisorption energy, and the result is shown in FIG. 6. The hydrogen adsorption sites of Pt and the Ir₅₀Au₅₀ alloy were compared, and are shown in FIG. 7.

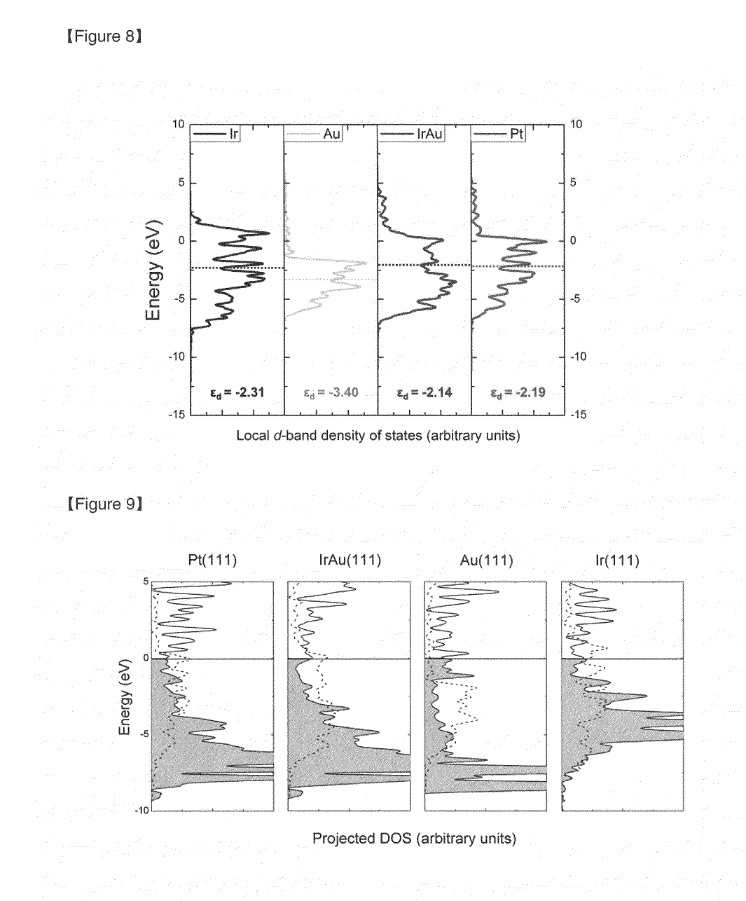

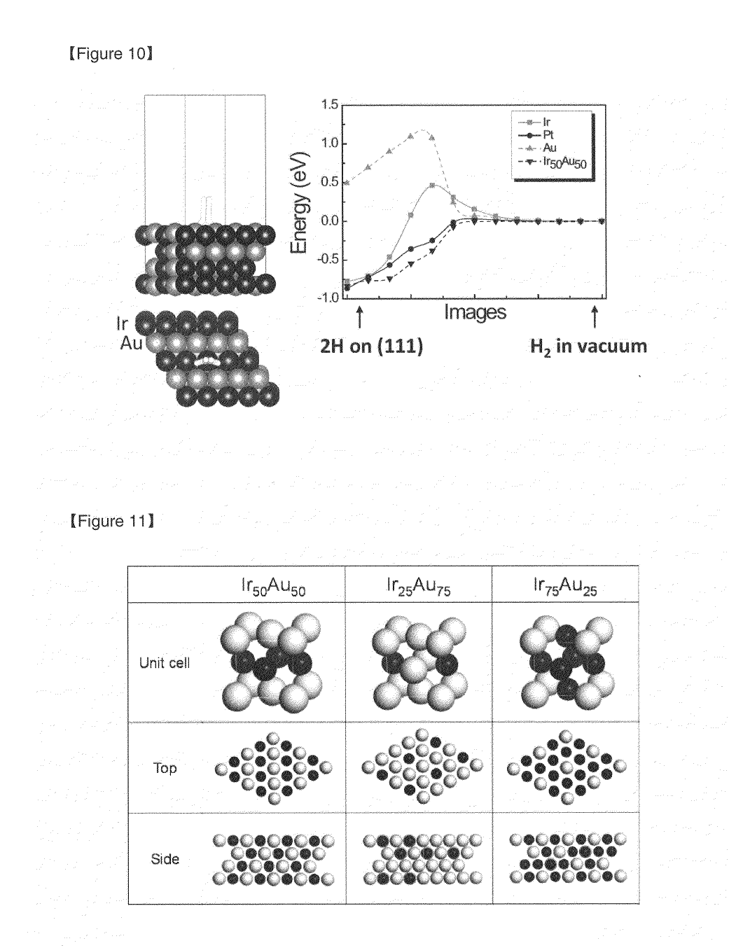

Furthermore, for the pure metals Pt, Ir, and Au and the Ir₅₀Au₅₀ alloy, the density of state of the d-band was calculated by using the density functional theory calculation equation, and the energy profiles are shown in FIG. 8. When the respective metals or the alloy are chemically adsorbed with hydrogen atoms, the densities of state were calculated, and the energy profiles are shown in FIG. 9. Under the condition that one hydrogen molecule is adsorbed over the (111) surface of a unit cell composed of four atoms, a minimum energy required for a hydrogen dissociation reaction was calculated, and the energy profiles are shown in FIG. 10.

Referring to FIG. 6, as a result of calculating the chemisorption energies at 11 sites, it can be confirmed that for the most preferential site, each hydrogen atom with an energy of −0.835 eV/H₂ is located between two adjacent Ir atoms. Referring to FIG. 7 in which the result is compared with Pt, it can be seen that the distances between the metal and hydrogen are 1.76 Å and 1.77 Å, respectively, and it can be confirmed that the sites in which hydrogen atoms are adsorbed are also identical.

When the energy profiles showing the density of state of the d-band are observed by referring to FIG. 8 (the contribution of the d-band is described in Example 3), it can be confirmed that the d-band centers of the Ir₅₀Au₅₀ alloy and Pt are −2.14 and −2.19, respectively, which are significantly similar to each other, when the d-band centers of Ir and Au are −2.31 and −3.40, respectively, and the line profiles of the Fermi energy of the Ir₅₀Au₅₀ alloy and Pt are also significantly similar to each other.

FIG. 9 is a line profile relative to the density of states when a hydrogen atom is chemically adsorbed on each metal or the alloy, a solid line represents a state in which the adsorption is achieved, a dotted line represents a line profile of the pure metals or the alloy in which the adsorption does not occur, and the Fermi energy is 0 eV. Referring to the line profiles, it can be seen that peaks which were not shown in the dotted line are shown in the solid line, indicating that these are peaks showing bonding and non-bonding resonances.

That is, it can be confirmed that the H 1s-orbital and the metal d-orbital bonding resonances for the Ir₅₀Au₅₀ alloy and Pt are shown at −5 to −10 eV, that the non-bonding resonances are all shown above the Fermi energies, and that the line profiles of the Ir₅₀Au₅₀ alloy and Pt are significantly similar to each other.

However, in the case of Au, the H 1s-orbital and metal d-orbital bonding resonances are positioned at −5 to −10 eV in a similar way to the Pt and the Ir₅₀Au₅₀ alloy, whereas the non-bonding resonances may be found at a position which is lower than the Fermi energy. Further, in the case of Ir, the H 1s-orbital and metal d-orbital non-bonding resonances were shown above the Fermi energy in a similar way to the Pt and the Ir₅₀Au₅₀ alloy, whereas the bonding resonances were shown at −3 to −7 eV. Accordingly, it can be confirmed that the bonding resonances are formed at an energy higher than the energies of Pt and the Ir₅₀Au₅₀ alloy.

Referring to FIG. 10, in the case of following a reaction path in which the hydrogen atom was adsorbed on the site over the Ir₅₀Au₅₀ alloy (111) surface, the energy barrier (Eₐ) was nearly zero, which was similar to 0.03 eV, which is an energy barrier when the hydrogen is adsorbed over the Pt (111) surface. In addition, the dissociation reaction energy (ΔH_{r×n}) of the Ir₅₀Au₅₀ alloy was −0.84 eV/2H, and it can be confirmed that the value is very close to −0.87 eV/2H, which is the dissociation reaction energy of Pt.

However, in the case of the Au metal, it can be confirmed that the dissociation reaction energy (ΔH_{r×n}) is positive (endothermic reaction), the energy barrier (Eₐ) was 1.09 eV in the case of adsorption over the Au (111) surface, which is considerably higher than the values of the alloy or Pt, and the Au metal does not have a function of adsorbing hydrogen and dissociating the hydrogen from the reactants as an endothermic reaction which may not achieve a spontaneous reaction. Furthermore, in the case of Ir, the dissociation reaction energy is negative (exothermic reaction), and a spontaneous reaction may occur. However, it can be confirmed that Ir also has no function of dissociating hydrogen because the energy barrier was 0.46 eV in the case of adsorption over the Ir (111) surface, and is not an energy barrier which can be easily overcome unlike the alloy or Pt.

The above-described results demonstrate that the Ir₅₀Au₅₀ alloy has physical properties which are significantly similar to those of Pt, and the alloy has a function of adsorbing hydrogen and dissociating the hydrogen.

### Example 4

### Atomic Arrangement in Accordance with Composition of Alloy in which Two Metals are Intermingled with Each Other

To confirm whether in the case of the Ir₅₀Au₅₀ alloy, the alloy may be prepared in another composition, the atomic arrangement was simulated in accordance with each composition ratio, and the result is shown in FIG. 11. Referring to this, it can be confirmed that the composition ratio of 25:75 to 75:25 may have an atomic arrangement which may all satisfy the results confirmed in the Examples and the Evaluative Example, and that the catalytic activity may be analogized and applied through the d-orbital band theory, and such catalytic effects of the alloys may be maintained in the composition range of 25:75 to 75:25.

While preferred embodiment of the present invention have been described in detail, it is to be understood that the scope of the present invention is not limited thereto, and various modifications and variations made by those skilled in the art using basic concepts of the present invention defined in the following claims also fall within the scope of the present invention.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A hydrogen dissociation catalyst comprising an alloy in which two metals are intermingled with each other, the alloy being an Ir—Au alloy.

2. The hydrogen dissociation catalyst of claim 1, wherein the alloy is a solid solution.

3. The hydrogen dissociation catalyst of claim 1, wherein the catalyst is an alternative catalyst to a platinum (Pt) catalyst.

4. The hydrogen dissociation catalyst of claim 1, wherein the catalyst has an activity for a hydrogen oxidation reaction (HOR).

5. The hydrogen dissociation catalyst of claim 4, wherein hydrogen is adsorbed over the alloy (111) surface.

6. The hydrogen dissociation catalyst of claim 1, wherein the alloy comprises a face centered cubic (FCC).

7. The hydrogen dissociation catalyst of claim 1, wherein a molar ratio of constituent atoms of the alloy is 25:75 to 75:25.

8. A hydrogen dissociation catalyst composition comprising an alloy in which two metals are intermingled with each other, the alloy being an Ir—Au alloy.

9. The catalyst composition of claim 8, wherein the alloy is a solid solution.

10. The catalyst composition of claim 8, wherein the composition has an activity for a hydrogen oxidation reaction.

11. The catalyst composition of claim 10, wherein hydrogen is adsorbed over the alloy (111) surface.

12. The catalyst composition of claim 8, wherein the alloy comprises a face centered cubic (FCC) structure.

13. The catalyst composition of claim 8, wherein a molar ratio of constituent atoms of the alloy is 25:75 to 75:25.

14. A hydrogen fuel cell comprising the hydrogen dissociation catalyst of claim 1.

15. A method for oxidizing hydrogen by using the hydrogen dissociation catalyst of claim 1.
